(19) United States
(12) Patent Application Publication
(10) Pub. No.: US 2016/0044664 A1
(43) Pub. Date: Feb. 11, 2016

(54) COMMUNICATION APPARATUS AND METHOD OF CONTROLLING THE SAME

(71) Applicant: CANON KABUSHIKI KAISHA, Tokyo (JP)

(72) Inventor: Hirohiko Inohiza, Yokohama-shi (JP)

(21) Appl. No.: 14/811,217

(22) Filed: Jul. 28, 2015

(30) Foreign Application Priority Data
Aug. 8, 2014 (JP) 2014-163045

(51) Int. Cl. H04W 72/04

(52) U.S. Cl. CPC H04W 72/0446

(57) ABSTRACT

A communication apparatus allocates timeslots, indicating intervals usable for transmission or reception of data, to each of a first and a second apparatuses, and communicates a result of the allocation to the first and the second apparatuses. The communication apparatus allocates the timeslots so that a timeslot allocated for the first apparatus to transmit/receive a first type of data to/from a partner apparatus overlaps with a timeslot allocated for the second apparatus to transmit/receive the first type of data to/from a partner apparatus, and a timeslot allocated for the first apparatus to transmit/receive a second type of data to/from a partner apparatus does not overlap with a timeslot allocated for the second apparatus to transmit/receive the second type of data to/from a partner apparatus.

### BACKGROUND OF THE INVENTION

1. Field of the Invention

The present invention relates to a communication apparatus, and a method of controlling the same.

2. Description of the Related Art

In recent years, increases in capacity of data transferred via a wireless network, including a family home network or a public telephone network, are progressing. When a plurality of users use such a wireless network simultaneously, transference of stream data for which a real-time capability is requested, such as video data or audio data, or transference of a stream for performing Web browsing or a file transfer, or the like may occur simultaneously. Accordingly, in such conditions, a situation occurs in which communication bandwidth for the wireless network is pressed.

One counter-measure for communication bandwidth being pressed is a millimeter radio wave wireless communication technique for realizing wireless communication at high speed and large capacity (for example, Japanese Patent Laid-Open No. 2013-090014). In the IEEE 802.11ad specification, which is a specification relating to millimeter radio wave wireless communication, a function called spatial sharing is defined. Spatial sharing is a function of, in a plurality of node pairs of a reception node and transmission node provided with directional antennas, avoiding interference on a wireless communication link between a node pair and spatially sharing a single frequency channel between the plurality of node pairs, by narrowing a directive angle of an antenna beam. With spatial sharing, it is possible for a plurality of node pairs to use timeslots that overlap on the time axis to perform data transferring, it is possible to reduce time necessary for data transferring compared to a case where spatial sharing is not performed, and wireless communication bandwidth can be used more efficiently.

However, during execution of spatial sharing, there are cases where an interference amount for a communication link for another node pair becomes higher due to an environment change, such as movement of a transmission node or a reception node. In such a case, it becomes easier for an error to occur in data transferred with an overlapped timeslot, leading to an adverse effect on an application requiring a real-time capability. For example, with video streaming when transferring data line-by-line in order from top to bottom of a video frame, an error may occur in a line transferred in an overlapped timeslot. In such a case, a video frame that is broken overall is received at the reception node, and deterioration or discontinuation occurs for the video playback.

### SUMMARY OF THE INVENTION

According to an embodiment of the present invention, a wireless communication system that reduces deterioration or discontinuation for streaming playback or the like when executing wireless communication that causes timeslots to overlap (wireless communication in which spatial sharing is performed) is disclosed.

According to one aspect of the present invention, there is provided a communication apparatus, comprising: an allocation unit configured to allocate timeslots, indicating intervals usable for transmission or reception of data, to each of a first communication apparatus and a second communication apparatus; and a notification unit configured to communicate a result of the allocation by the allocation unit to the first communication apparatus and the second communication apparatus, wherein the allocation unit allocates the timeslots so that, from the timeslots allocated to the first communication apparatus and the timeslots allocated to the second communication apparatus, a timeslot allocated for the first communication apparatus to transmit or receive a first type of data to or from a partner apparatus is caused to overlap with a timeslot allocated for the second communication apparatus to transmit or receive the first type of data to or from a partner apparatus, and a timeslot allocated for the first communication apparatus to transmit or receive a second type of data to or from a partner apparatus is caused not to overlap with a timeslot allocated for the second communication apparatus to transmit or receive the second type of data to or from a partner apparatus.

According to another aspect of the present invention, there is provided a communication apparatus operable to manage timeslots which are for a plurality of nodes to time-divisionally transmit/receive data in a wireless communication network, comprising: a classification unit configured to classify data transmitted/received by the plurality of nodes into data that falls under a first type and data that falls under a second type; and an allocation unit configured to allocate data that falls under the first type to a timeslot for which spatial sharing is inhibited, and allocate data that falls under the second type to a timeslot for which spatial sharing is caused to occur.

According to another aspect of the present invention, there is provided a control method for a communication apparatus, the method comprising: allocating timeslots, indicating intervals usable for transmission or reception of data, to each of a first communication apparatus and a second communication apparatus; and communicating a result of the allocation in the allocation step to the first communication apparatus and the second communication apparatus, wherein, in the allocating, the timeslots are allocated so that, from the timeslots allocated to the first communication apparatus and the timeslots allocated to the second communication apparatus, a timeslot allocated for the first communication apparatus to transmit or receive a first type of data to or from a partner apparatus is caused to overlap with a timeslot allocated for the second communication apparatus to transmit or receive the first type of data to or from a partner apparatus, and a timeslot allocated for the first communication apparatus to transmit or receive a second type of data to or from a partner apparatus is caused not to overlap with a timeslot allocated for the second communication apparatus to transmit or receive the second type of data to or from a partner apparatus.

Furthermore, according to another aspect of the present invention, there is provided a control method for a communication apparatus configured to manage timeslots which are for a plurality of nodes to time-divisionally transmit/receive data in a wireless communication network, the method comprising: classifying data transmitted/received by the plurality of nodes into data that falls under a first type and data that falls under a second type; and allocating data that falls under the first type to a timeslot for which spatial sharing is inhibited, and allocate data that falls under the second type to a timeslot for which spatial sharing is caused to occur.

Further features of the present invention will become apparent from the following description of exemplary embodiments with reference to the attached drawings.

### BRIEF DESCRIPTION OF THE DRAWINGS

FIG. 1 is a view showing a configuration of a wireless communication system according to a first embodiment.

FIG. 2 is a block diagram for showing an example of the arrangement of a control node.

FIG. 3 is a block diagram for showing an example of the arrangement of a transmission node.

FIG. 4 is a block diagram for showing an example of the arrangement of a reception node.

FIG. 5 is a view for explaining an example of a configuration of communication frames.

FIGS. 6A and 6B are views showing a sequence for transferring video data.

FIG. 7 is a flowchart for showing operations of the control node.

FIG. 8 is a flowchart for showing timeslot allocation operations when spatial sharing.

FIG. 9 is a flowchart for showing operations of the transmission node.

FIG. 10 is a flowchart for showing operations of the reception node.

FIGS. 11A and 11B are views for describing an example of request/function information and allocation/configuration information according to the first embodiment.

FIG. 12 is a view for explaining timeslot allocation according to the first embodiment.

FIGS. 13A and 13B are views for describing another example of request/function information and allocation/configuration information according to the first embodiment.

FIG. 14 is a view for explaining another example of timeslot allocation according to the first embodiment.

FIGS. 15A and 15B are views for describing an example of request/function information and allocation/configuration information according to a second embodiment.

FIG. 16 is a view for explaining timeslot allocation according to the second embodiment.

### DESCRIPTION OF THE EMBODIMENTS

Hereinafter, explanation will be given for several suitable embodiments of the present invention, with reference to attached drawings.

### First Embodiment

For a first embodiment, explanation is given, taking as an example a configuration of stream transferring video data as stream data. For a wireless communication system of the present embodiment, it is possible for at least two sets of a transmission node and a reception node to share a space, and use a single frequency channel to transfer data via timeslots overlapping on the time axis. Of course, the present invention is also applicable to a wireless communication system in which three or more sets of transmission/reception nodes are present.

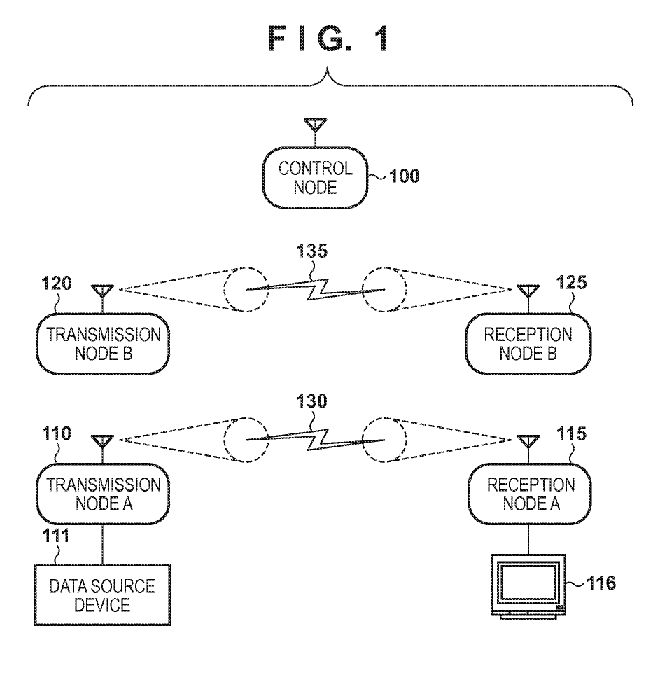

FIG. 1 is a view for illustrating an example configuration of a network for a wireless communication system of the first embodiment. The wireless communication system of the present embodiment has a single control node 100 as a communication apparatus, a transmission node A 110, a transmission node B 120, a reception node A 115, and a reception node B 125. The wireless communication system of the present embodiment performs communication via a wireless network, by using TDMA (Time Division Multiple Access). Each communication node performs transmission/reception of data through a timeslot allocated by the control node 100. Note that in the present example, the control node 100 is a separate communication node to a transmission node or a reception node, but configuration may also be taken such that one of the transmission nodes or the reception nodes functions as the control node.

In the wireless communication system of FIG. 1, the following conditions are assumed. The transmission node A 110 uses a communication link 130 to wirelessly transfer video streaming data obtained from a data source device 111 to the reception node A 115. As the data source device 111, a device such as a digital video camera, a hard disk, a digital video recorder, a PC, or a set-top box is envisioned. The reception node A 115 outputs received video streaming data to a display 116. Meanwhile, the transmission node B 120 uses a communication link 135 to perform data transferring to the reception node B 125. The data handled by the transmission node B 120 may be data for which a real-time capability is required, such as video data, or may be data for which a real-time capability is not required, such as file data.

Note that communication nodes (transmission node, reception node) configuring the wireless communication system of FIG. 1 is provided with directional antenna, and interference between the communication link 130 and the communication link 135 is prevented, or an interference amount is reduced by narrowing a directive angle of an antenna beam for transmission/reception. Thus, when the interference amount is low, it becomes possible to communicate by overlapping timeslots for the communication link 130 and the communication link 135 via spatial sharing. For example, the wireless communication system shown in FIG. 1 is a wireless communication system capable of realizing spatial sharing through the IEEE 802.11ad specification, which is a specification relating to millimeter radio wave wireless communication.

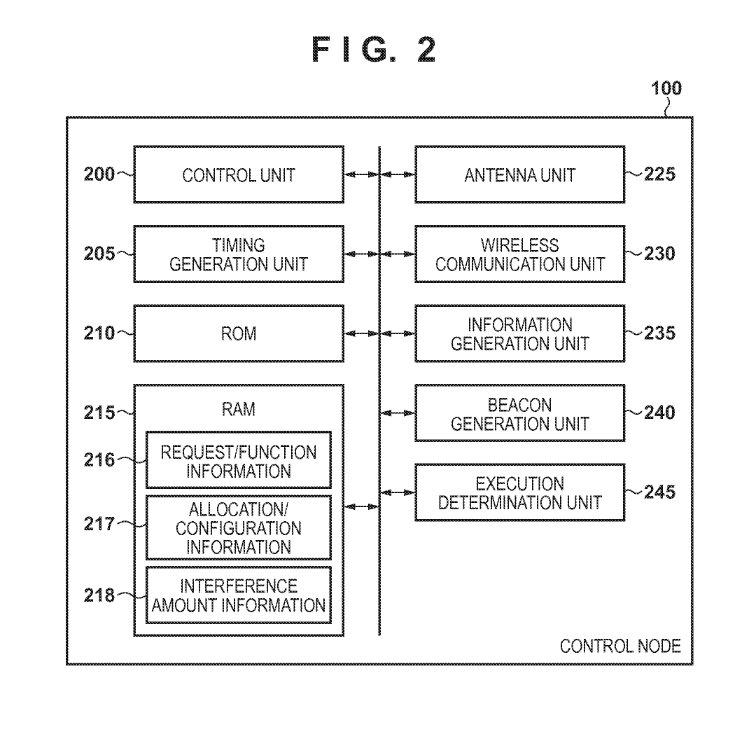

Next, FIG. 2 to FIG. 4 are used to give an explanation of an internal configuration of the communication apparatuses (the control node 100, transmission nodes 110, 120, and reception nodes 115, 125) configuring the wireless communication system of the present embodiment.

FIG. 2 is a block diagram showing an internal configuration of the control node 100 that manages timeslots, which are for a plurality of nodes in the wireless communication network to transmit/receive data time-divisionally. A control unit 200 controls overall operations within the control node 100. The control unit 200 realizes predetermined processing by a CPU (not shown) executing a program stored on a memory (for example, a ROM 210). A timing generation unit 205 generates timing for transmission and reception processing (transmit/receive timing). This transmit/receive timing is determined by timeslot allocation information included in allocation/configuration information 217 stored in a RAM 215. The ROM 210 is a non-volatile read-only memory, and stores a program and parameters for the control node. The RAM 215 is a volatile memory for which reading/writing as necessary is possible, and the RAM 215 stores various parameters or data.

Stored in the RAM 215 is request/function information 216, the allocation/configuration information 217, and interference amount information 218. The request/function information 216 is information indicating a timeslot allocation request received from a transmission node and a function for dividing source data into data blocks. The timeslot allocation request includes a kind and a data size for transmission data. The function information indicates the presence or absence of a function for the transmission node to divide data blocks having different priorities from source data, and the division status. For example, if the source data is the video data (source video data), the presence or absence of a function to configure the source video data into high priority video blocks and a low priority video blocks is indicated. The allocation/configuration information 217 includes data block configuration information and timeslot allocation information notified to a communication apparatus (transmission node, reception node) within the network. The timeslot allocation information includes transmit/receive timing for each timeslot (in this embodiment, an interval since a beacon signal), a duration for each timeslot (hereinafter, timeslot length), and identification information indicating a transmission source and a reception destination for data. The data block configuration information indicates allocation of a data block to a timeslot in accordance with the above described function information. The interference amount information 218 is collected from each reception node before the control unit 200 executes spatial sharing, and is used to determine whether to perform spatial sharing based on an interference amount between communication links. It will be explained later, but each reception node measures an interference amount for a radio wave from a communication link formed by each pair of nodes the reception node is not included in.

An antenna unit 225 has an antenna for emission/absorption of wireless data. A wireless communication unit 230 performs control of a transmit/receive directive angle of the antenna unit 225, or signal processing for wireless data transmission/reception. An information generation unit 235 determines, based on the request/function information 216 stored in the RAM 215, a timeslot allocation and a data block configuration for each of the transmission nodes, and stores these as the allocation/configuration information 217 in the RAM 215. A beacon generation unit 240 generates control information that includes the timeslot allocation information and the data block configuration information for each transmission node, based on the allocation/configuration information 217 stored in the RAM 215, and generates a beacon that includes the control information. An execution determination unit 245 determines whether to execute spatial sharing, based on the interference amount information 218 collected from each reception node and stored in the RAM 215, before executing spatial sharing. Note that all or a part of the timing generation unit 205, the wireless communication unit 230, the information generation unit 235, the beacon generation unit 240 and the execution determination unit 245 may be realized by the CPU of the control unit 200 executing a program, or may be realized as hardware.

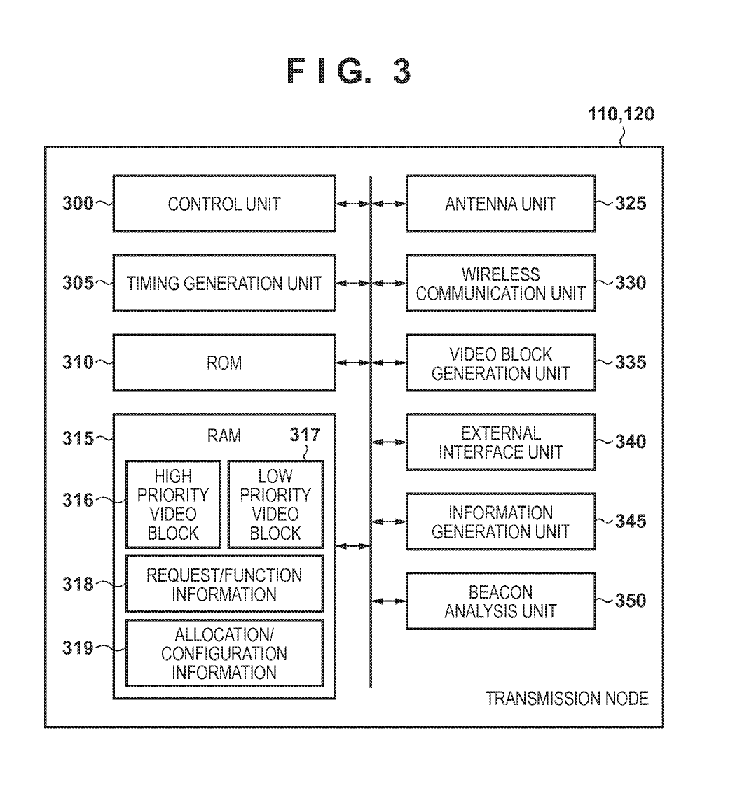

FIG. 3 is a block diagram showing an internal configuration example of a transmission node (the transmission node A 110, the transmission node B 120). Note that below, the above described of configuration in which video data is processed as source data is given as an example. Thus, there are cases below where a data block obtained by dividing the source data is referred to as a video block. A control unit 300 controls overall operations within the transmission node. The control unit 300 realizes predetermined processing by a CPU (not shown) executing a program stored on a memory (for example, a ROM 310). A timing generation unit 305 generates timing for transmission and reception processing (transmit/receive timing). The transmit/receive timing is determined using the timeslot allocation information (allocation/configuration information 319) stored in a RAM 315. The ROM 310 is a read-only non-volatile memory, and stores a program or parameters for a transmission node. The RAM 315 is a volatile memory for which reading/writing as necessary is possible, and the RAM 315 stores various parameters, data or the like.

The RAM 315 stores a high priority video block 316, and a low priority video block 317. The high priority video block 316 is a high priority video block generated by a video block generation unit 335 based on the source video data. The low priority video block 317 is a low priority video block generated by the video block generation unit 335 based on the source video data. Note that the high priority video block 316 contains a portion of fundamental video information to which human vision is sensitive, and the low priority video block 317 includes supplementary information which, while human vision is not sensitive to, does improve video quality. For example, if each video pixel includes as color information 8 bits for data for each of R, G, and B components (each RGB data item), the MSBs (Most Significant Bits), which are the higher 4 bits for each RGB data item, are set as the high priority video block 316. Also, the LSBs (Least Significant Bits), which are the lower 4 bits for each RGB data item, are set as the low priority video block 317. By synthesizing the high priority video block 316 and the low priority video block 317, data having the same content as the source video data obtained from the data source device 111 can be generated. Also, even if only the high priority video block 316 is used, the situation is such that a portion of color information is missing, but it is possible to generate a video frame that is not broken on the whole.

The RAM 315 also stores request/function information 318 and the allocation/configuration information 319. The request/function information 318 includes the timeslot allocation request, which includes a type or data size of transmission data that a transmission node requests of the control node, and function information that indicates a function by which the transmission node generates video blocks having differing priority from the source video data. The allocation/configuration information 319 is received from the control node 100. The allocation/configuration information 319 includes timeslot allocation information, which includes the transmit/receive timing and timeslot length for a timeslot within a communication frame, and timeslot configuration information indicating allocation of a data block to the timeslot. The timeslot allocation information and the timeslot configuration information are extracted from a beacon received via an antenna unit 325, by using a beacon analysis unit 350.

The antenna unit 325 has an antenna for emission/absorption of wireless data. A wireless communication unit 330 performs control of the transmit/receive directive angle of the antenna unit 325, or signal processing for wireless data transmission/reception. The video block generation unit 335 generates a plurality of video blocks having different priorities from the source video data received by an external interface unit 340, in accordance with data block configuration information stored as the allocation/configuration information 319. As described above, in this embodiment, the high priority video block 316 and the low priority video block 317 are generated. The external interface unit 340 receives the source video data from the data source device 111. An information generation unit 345 generates the timeslot allocation request and the function information, which are stored in the RAM 315 as the request/function information 318. The beacon analysis unit 350 analyzes the beacon received from the control node 100, extracts timeslot allocation information and video block configuration information, and stores this as the allocation/configuration information 319 in the RAM 315. Note that all or a part of the timing generation unit 305, the wireless communication unit 330, the video block generation unit 335, the information generation unit 345, and the beacon analysis unit 350 may be realized by the CPU of the control unit 300 executing a program. Also, these may be realized by hardware.

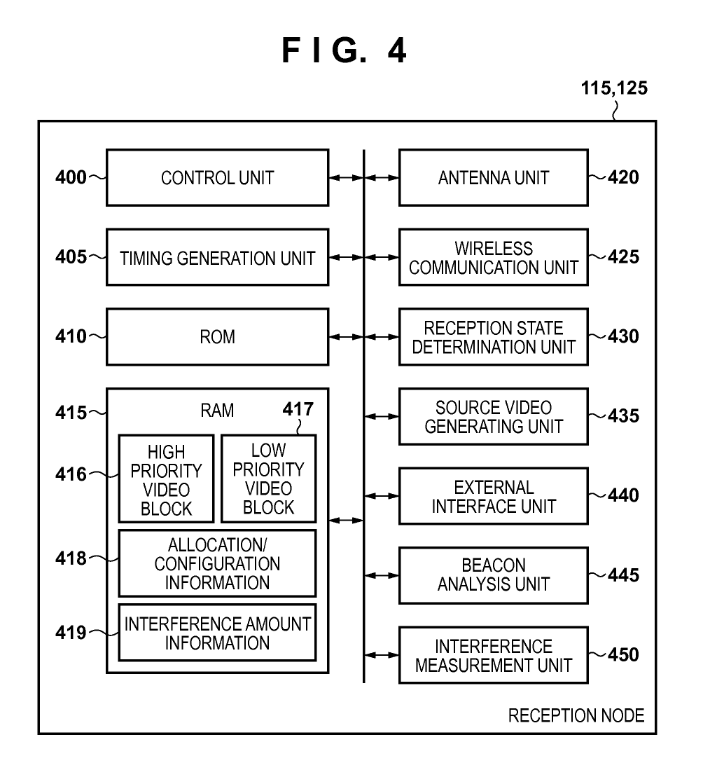

FIG. 4 is a block diagram showing an internal configuration example of a reception node (the reception node A 115, the reception node B 125). A control unit 400 controls overall operations within the reception node. The control unit 400 realizes predetermined processing by a CPU (not shown) executing a program stored on a memory (for example, a ROM 410). A timing generation unit 405 generates timing for transmission and reception processing (transmit/receive timing). Note that the transmit/receive timing is determined by timeslot allocation information (stored in a RAM 415) received by wireless communication. The ROM 410 is a read-only non-volatile memory, and stores programs or parameters for the reception node. The RAM 415 is a volatile memory for which reading/writing as necessary is possible, and stores various parameters, data or the like.

The RAM 415 stores a high priority video block 416, a low priority video block 417, allocation/configuration information 418, and interference amount information 419. The high priority video block 416 and the low priority video block 417 are video block data received from a transmission node by wireless communication. The allocation/configuration information 418 includes timeslot allocation information, which includes the transmit/receive timing and timeslot length for a timeslot within a communication frame, and data block configuration information indicating allocation of a video block to the timeslot. The interference amount information 419 indicates an interference amount that an interference measurement unit 450 measures by a timeslot with which a pair of a transmission node and another reception node (communication by this pair is a candidate for spatial sharing being performed with communication that the reception node performs itself) are performing data transferring.

An antenna unit 420 has an antenna for emission/absorption of wireless data. A wireless communication unit 425 performs control of a transmit/receive directive angle of an antenna, or signal processing for wireless data transmission/reception. A reception state determination unit 430 determines a reception state of the video block received from the transmission node. A source video generating unit 435 generates source video data from the received video block and the determination result of the reception state thereof. An external interface unit 440 is an interface for outputting the source video data to the display 116. A beacon analysis unit 445 analyzes the beacon received from the control node 100, and extracts the timeslot allocation information and the video block configuration information, which are then stored as the allocation/configuration information 418 in the RAM 415. Note that all or a part of the timing generation unit 405, the wireless communication unit 425, the reception state determination unit 430, the source video generating unit 435, the beacon analysis unit 445 and the interference measurement unit 450 may be realized by the CPU of the control unit 300 executing a program. Also, these may be realized by hardware.

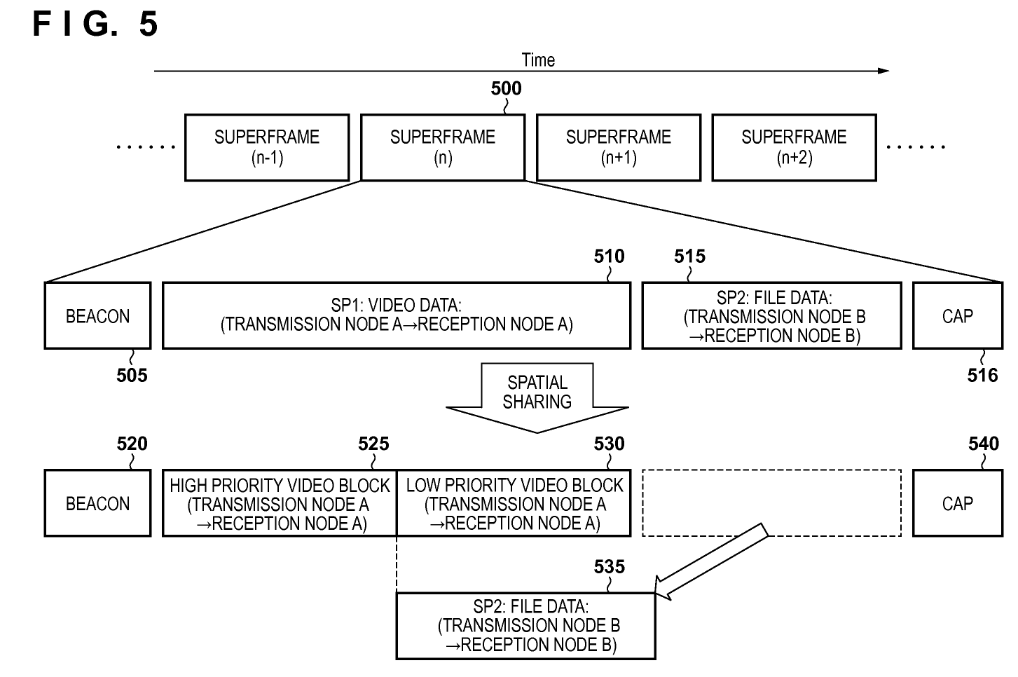

Next, explanation is given using FIG. 5 regarding a configuration of a communication frame according to this embodiment. FIG. 5 is a view showing a configuration of a superframe 500 in the wireless communication system of the present embodiment. The superframe 500 has a fixed length, and is repeated at a predetermined period. The superframe 500 is configured from timeslots for a beacon, an SP (Service Period), and a CAP (Contention Access Period). The beacon is arranged at the head of the superframe, and includes timeslot allocation information or the like that stipulates allocation of every timeslot, including an SP and a CAP. Note that the beacon is communicated to every transmission node and reception node from the control node 100. The SP is a timeslot reserved for data transferring between a specific transmission node and reception node, and is used to transfer application/data frames for video data transfer, file transfer, or the like. A contention access format, such as CSMA/CA (Carrier Sense Multiple Access/Collision Avoidance) is used with the CAP. The CAP is for data block configuration information or a timeslot allocation request for the transmission node and the reception node, and is used for notifying information such as interference amount information measured by the reception node.

The timeslots 505, 510, 515, 516 each indicate a communication frame configuration (beacon, SP, CAP) for a state in which spatial sharing is not executed. In the timeslot 510, transferring of video data from the transmission node A 110 to the reception node A 115 is performed. In the timeslot 515, transferring of file data from the transmission node B 120 to the reception node B 125 is performed. When spatial sharing is not executed, these SPs (timeslot 510, timeslot 515) do not mutually overlap.

As preparation before executing spatial sharing, the control node 100 performs a collection of interference amount information from each reception node. The interference measurement unit 450 of the reception node B 125 measures the interference amount (for example, radio field intensity received by the antenna unit 420) while data transferring is being performed from the transmission node A 110 to the reception node A 115, in the interval of the timeslot 510. The interference measurement unit 450 of the reception node A 115 measures the interference amount while data transferring is being performed from the transmission node B 120 to the reception node B 125, in the interval of the timeslot 515. The measured interference amount (the interference amount information 419) is notified by the reception node to the control node 100, by using the CAP timeslot. The control node 100 starts spatial sharing if the control node 100 determines that the interference amount is within a range in which it does not affect the communication statuses of others, based on the obtained interference amount information.

The timeslots 520, 525, 530, 535 and 540 each indicate a communication frame configuration for a state in which spatial sharing is executed. The transmission node A 110 performs time division transferring by dividing the source video data into a high priority video block and a low priority video block, which are then transferred via the timeslot 525 and the timeslot 530 respectively. File data, which had been transferred at timing subsequent to the video block before spatial sharing (the timeslot 515), is transferred in the timeslot 535, which overlaps with the timeslot 530 of the low priority video block, after spatial sharing. Thereby, even if hypothetically the interference amount for data transferring of the timeslot 530 and the timeslot 535 rises and an error occurs in reception of the low priority video block in the timeslot 530, it is possible to play back the video data based on the high priority video block 416 received through the timeslot 525. As a result, reducing deterioration or discontinuation of video playback is possible. Meanwhile, it is possible to perform a data transfer of file data without a problem by performing a re-transmission of data.

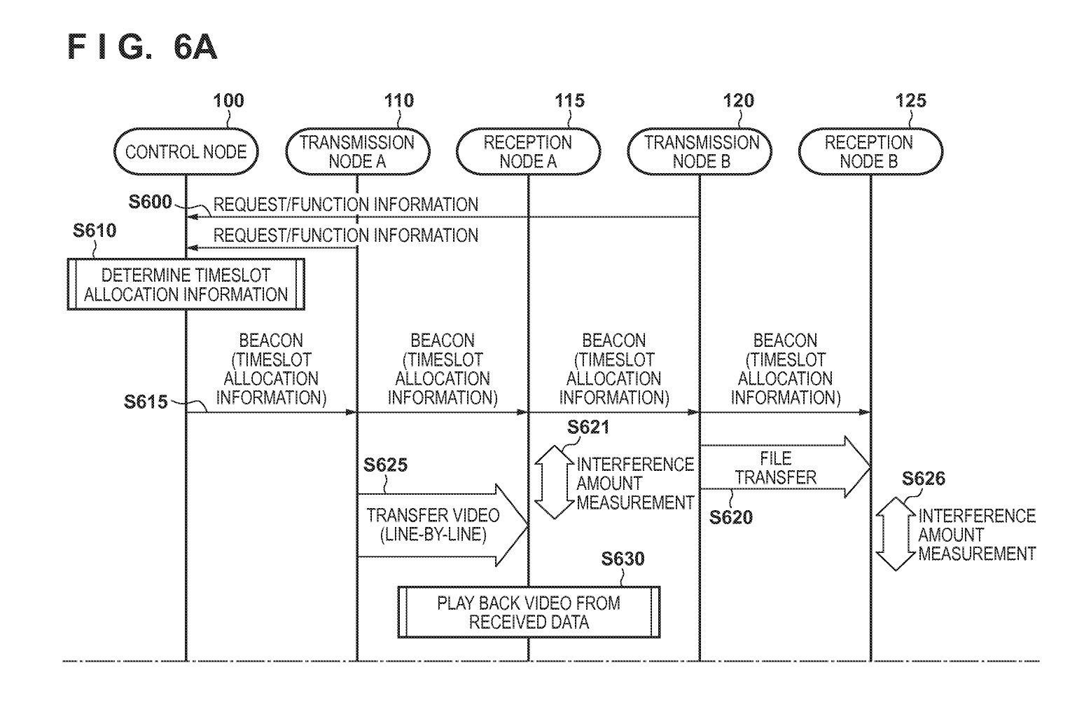

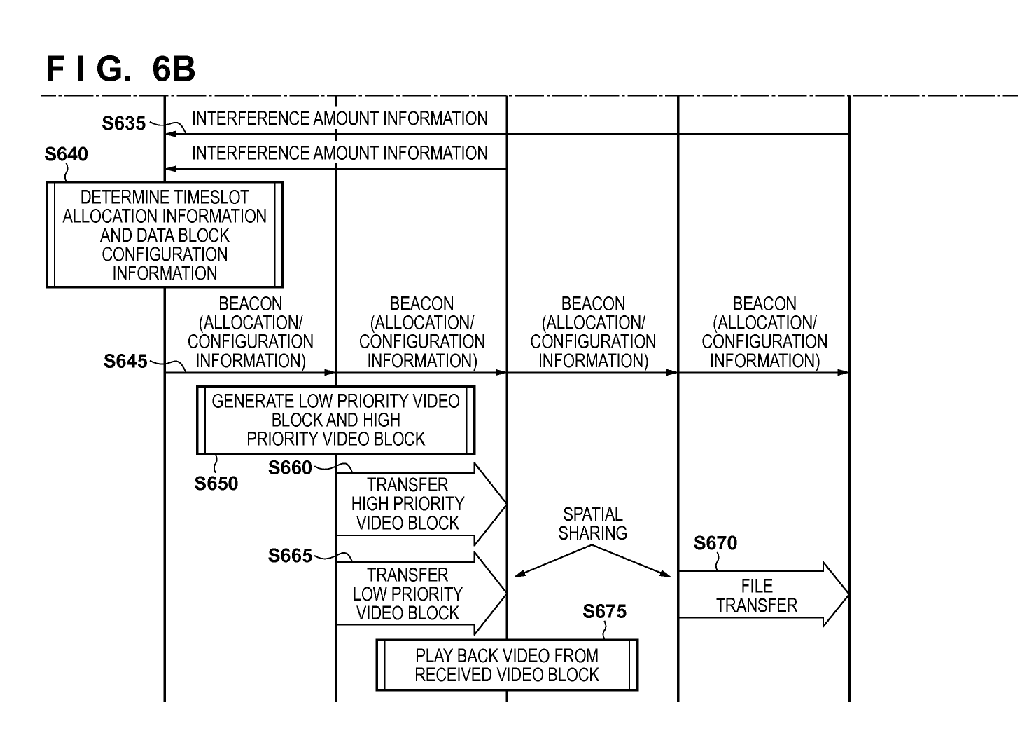

Next, explanation is given of the flow of the overall operation of video data transfer in the present embodiment, using the sequence diagram of FIGS. 6A and 6B.

Firstly, the control node 100 obtains function information (the request/function information 216) relating to the configuration of the video block and the timeslot allocation request from the transmission node B 120 and the transmission node A 110 in the network (step S600). Next, the control node 100, based on collected timeslot allocation requests, first determines the timeslot allocation information in a state of not executing spatial sharing (step S610), and then communicates a beacon that stores the timeslot allocation information (step S615) to all transmission nodes and reception nodes. While the transmission node B 120 transfers file data to the reception node B 125 in accordance with the timeslot allocation information (step S620), and as advance preparation for spatial sharing, the reception node A 115 measures the interference amount (step S621). The transmission node A 110 transfers video data line-by-line to the reception node A 115 in accordance with the timeslot allocation information (step S625). Meanwhile, as advance preparation for spatial sharing, the reception node B 125 measures the interference amount (step S626). Using data the reception node A 115 receives from the transmission node A 110 (step S625), the reception node A 115 plays video (step S630). The interference amount information indicates the interference amount measured at each reception node in step S621 and step S626 is notified to the control node 100 (step S635). In this way, data transferring is first performed in a state in which spatial sharing is not executed.

Next, explanation is given of operations for when spatial sharing is executed. Based on the interference amount information collected in step S635 and the request/function information 216 collected in step S600, the control node 100 determines the allocation/configuration information 217 for executing spatial sharing (step S640). Next, the control node 100 communicates beacon, in which this information is stored, to every transmission node and reception node (step S645). Next, based on the allocation/configuration information received from the control node 100, the transmission node A 110 divides the source video data into the low priority video block and the high priority video block (step S650). The transmission node A 110 transfers the high priority video block in a state in which there is no overlap with another timeslot (step S660), and subsequently transfers the low priority video block (step S665). The transmission node B 120 transfers file data in a timeslot that temporally overlaps with the timeslot in which the low priority video block is transferred (step S670). Thus, low priority video block and file data are transferred by using spatial sharing.

The reception node A 115 receives both the high priority video block and the low priority video block, and then plays the video (step S675). Here, if the reception node A 115 failed to receive the low priority video block, the reception node A 115 uses only the high priority video block to generate the source video data, and then plays the video. Meanwhile, if the reception node A 115 successfully received both the high priority video block and the low priority video block, the reception node A 115 combines both blocks to generate the source video data, and then plays the video.

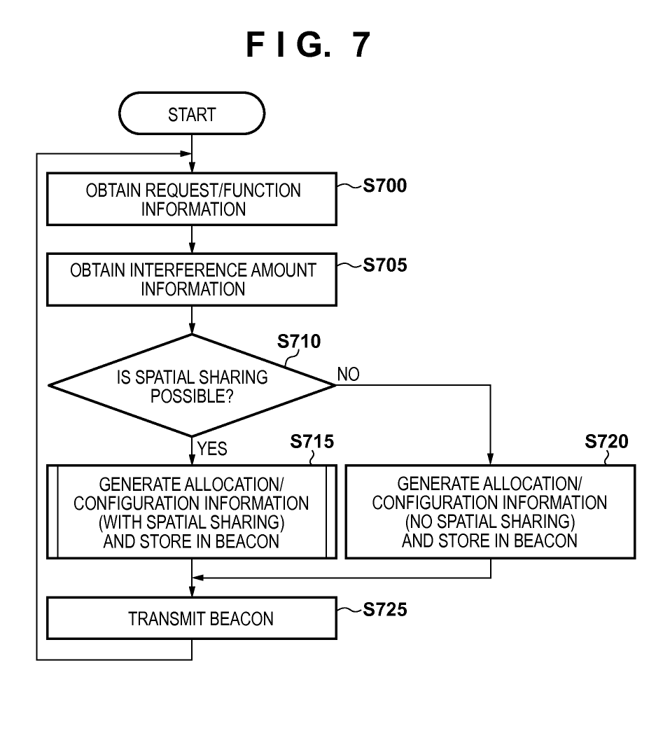

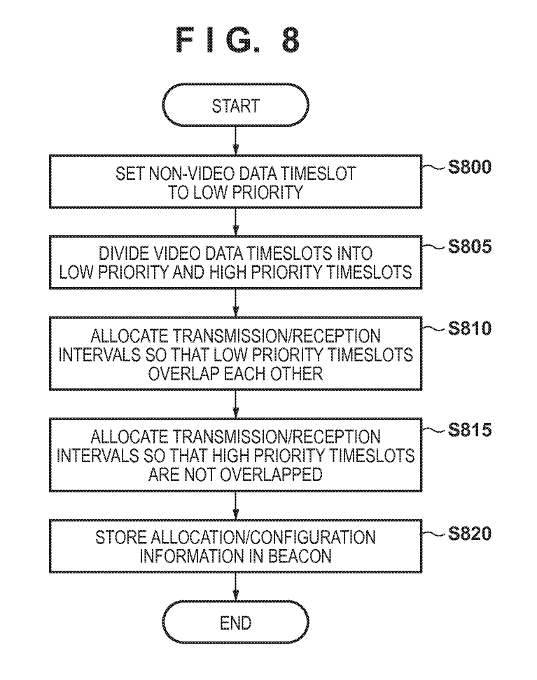

Next, explanation is given regarding details of internal operations of the control node 100 in units of superframes using the flowcharts of FIG. 7 and FIG. 8.

Firstly, the control unit 200 of the control node 100 obtains information of a timeslot allocation request from the transmission node and function information regarding the configuration of the video block (request/function information) from the CAP (step S700). The control unit 200 obtains the interference amount information, which is from the reception node, from the CAP (step S705). Next, the execution determination unit 245 determines whether spatial sharing can be executed, for the obtained timeslot allocation request (step S710). In this embodiment, if the interference amount notified from the reception node is less than a predetermined threshold, it is determined that spatial sharing can be executed and processing branches to step S715, and if the interference amount is greater than or equal to the predetermined threshold, it is determined that spatial sharing cannot be executed, and processing branches to step S720.

If it is determined that spatial sharing can be executed, the information generation unit 235 generates allocation/configuration information that includes video block configuration information and timeslot allocation information, which causes timeslots to overlap temporally, for executing spatial sharing. The beacon generation unit 240 stores control information that includes the allocation/configuration information generated by the information generation unit 235 in the beacon (step S715). If it is determined not to execute spatial sharing, the information generation unit 235 generates allocation/configuration information that includes timeslot allocation information that does not cause timeslots to overlap temporally. The beacon generation unit 240 stores control information that includes the generated allocation/configuration information in the beacon (step S720). The wireless communication unit 230 communicates the generated beacon to all of the transmission nodes and the reception nodes (step S725). Thereafter, processing returns to step S700, and the above-described processing repeats.

FIG. 8 is a flowchart for showing one example of the processing in step S715 of FIG. 7 (processing to generate and store in the beacon control information that includes the allocation/configuration information that causes timeslots to overlap). Firstly, in step S800, the information generation unit 235 of the control node 100 sets a timeslot request for an application other than video data transferring to low priority. Thereby, for example, the timeslot for performing file transfer is set to low priority. Next, the information generation unit 235 divides timeslots for video data transferring into low priority and high priority timeslots (step S805). The low priority timeslot is a timeslot for transmitting the low priority video block 317, and the high priority timeslot is a timeslot for transmitting the high priority video block 316.

Next, the information generation unit 235 determines timing for the timeslots (temporal allocation). Firstly, the information generation unit 235 allocates timeslots set to low priority to transmission/reception intervals that overlap temporally (step S810) Thereby, for example, temporally overlapped transmit/receive timings are allocated to a timeslot for file transfer and a timeslot for transfer of the low priority video block. The information generation unit 235 allocates a timeslot for the high priority video block to transmit/receive timing that does not overlap with another timeslot (step S815) temporally. Then the information generation unit 235 communicates the determined timeslot allocation information and video block configuration information to the beacon generation unit 240. The beacon generation unit 240 generates a beacon that stores control information that includes data block configuration information indicating the timeslot allocation information and video block configuration, which were communicated from the information generation unit 235 (step S820).

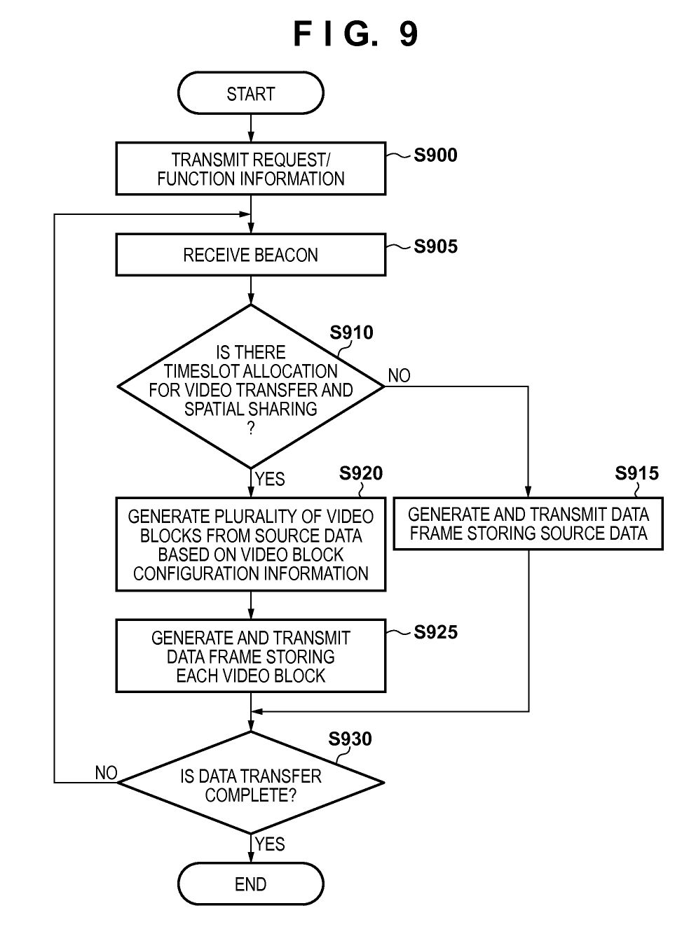

Next, explanation is given using the flowchart of FIG. 9 regarding details of internal operations from the start of data transferring until the completion thereof, which are performed by a transmission node.

Firstly, when starting data transferring, the transmission node uses the CAP timeslot to transmit to the control node 100 the timeslot allocation request information, and, in the case of transferring video data, function information indicating a function relating to dividing the video block (step S900). Next, the wireless communication unit 330 receives a beacon, to which a timeslot has been allocated, from the control node 100 (step S905). The beacon analysis unit 350 determines whether spatial sharing is being executed and whether the timeslot allocation is for transferring the video data, by analyzing the timeslot allocation information included in the beacon received in step S905 (step S910). As a result, if it is determined that the timeslot allocation is for a timeslot for transferring the video data and that spatial sharing is specified, processing branches to step S920, otherwise processing branches to step S915.

If spatial sharing is not designated, or if not the case of a timeslot for transferring video, division of video data is not requested. Accordingly, the control unit 300 directly uses the source data to generate a data frame, and then transmits the data frame in accordance with the timeslot allocation information (step S915). Meanwhile, in the case of a timeslot for video transfer and where spatial sharing is specified, division of the video data is requested. The video block generation unit 335 generates a plurality of video blocks having different priorities from the source video data that is the transmission target, based on the data block configuration information for the timeslot (step S920). In this embodiment, the high priority video block and the low priority video block are generated. Then the control unit 300 stores the video blocks in a data frame in accordance with the timeslot allocation information and the data block configuration information, and transmits the data frame (step S925). Thereafter, the control unit 300 performs a check for whether necessary data transferring has completed, and returns processing to step S905 and repeats the above described process if not completed, or terminates processing if completed (step S930).

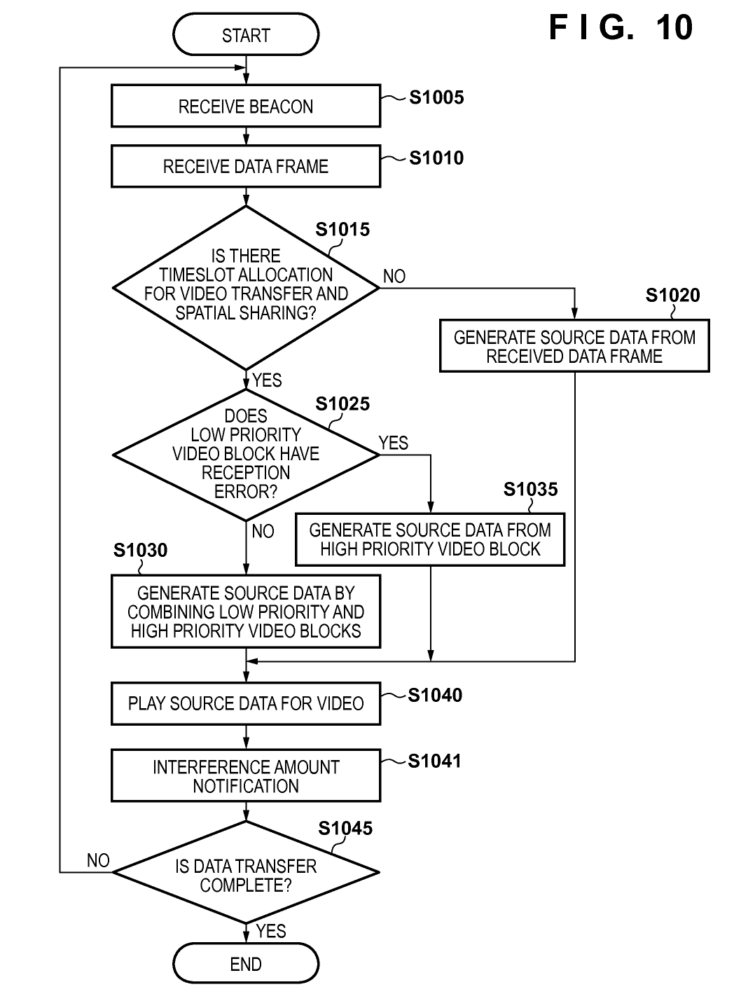

Next, explanation is given using the flowchart of FIG. 10 regarding details of internal operations from the start of data transferring until the completion thereof, which are performed by a reception node.

In the reception node, the wireless communication unit 425 receives the beacon, for which a timeslot was allocated, from the control node 100 (step S1005). Subsequently, in accordance with the timeslot allocation information included in the beacon, the wireless communication unit 425 receives a data frame addressed to itself (step S1010). Next, the reception state determination unit 430 determines whether the timeslot allocation for the received data frame is for transferring video data, and whether spatial sharing is executed (step S1015). If the time slot allocation is a time slot for transferring video data and spatial sharing is executed, processing branches to step S1025, otherwise processing branches to step S1020.

If the time slot allocation is not a timeslot for transferring video data or if spatial sharing is not executed, there is no necessity to reconfigure the source video data from a plurality of video blocks. The source video generating unit 435 then directly generates the source data from the received data frame (step S1020). The control unit 400 uses the source video data generated in step S1020 to execute video playback (step S1040).

Meanwhile, if the time slot allocation is a time slot for transferring video data and also spatial sharing is executed, the reception state determination unit 430 determines a reception state for the low priority video block from the received data frame (step S1025). If the low priority video block could be received normally, processing branches in step S1030, and if an error occurred in the reception of the low priority video block, processing branches to step S1035. If the low priority video block was able to be received normally, the source video generating unit 435 generates the source video data by combining the low priority video block and the high priority video block, based on the video block configuration information included in the beacon (step S1030). If an error occurred in reception of the low priority video block, the source video generating unit 435 generates the source video data from the high priority video block without using the low priority video block (step S1035). The control unit 400 uses the source video data generated in step S1030 or step S1035 to play back the video (step S1040).

In parallel with the above described playback of the source data, the interference measurement unit 450 specifies, from the slot allocation information of the received beacon, a timeslot other than the timeslot allocated to the reception node itself, and measures an interference amount for a communication link formed by a node pair in the specified timeslot. The interference amount is, for example, based on a detected radio field intensity. In CAP the control unit 400 communicates the interference amount measured by the interference measurement unit 450 (the interference amount information 419) (step S1041) to the control node 100. Thereby, the measurement of an interference amount (step S621, step S626) and notification of interference amount information (step S635), described above through FIGS. 6A and 6B, are performed. In addition, through the notification of this interference amount, the control node 100 is able to determine whether to perform spatial sharing for each superframe. Thereafter, the control unit 400 performs a check for whether necessary data transferring has completed, returns processing to step S1005 and repeats the above described process if not completed; if necessary data transferring has completed, this processing terminates (step S1045).

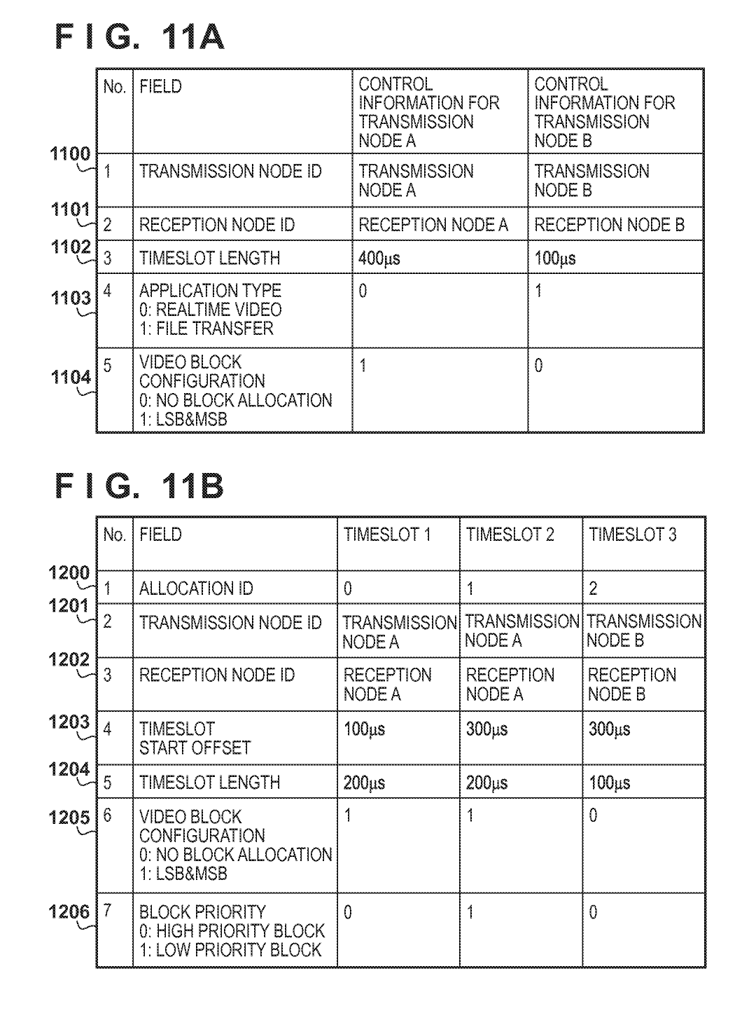

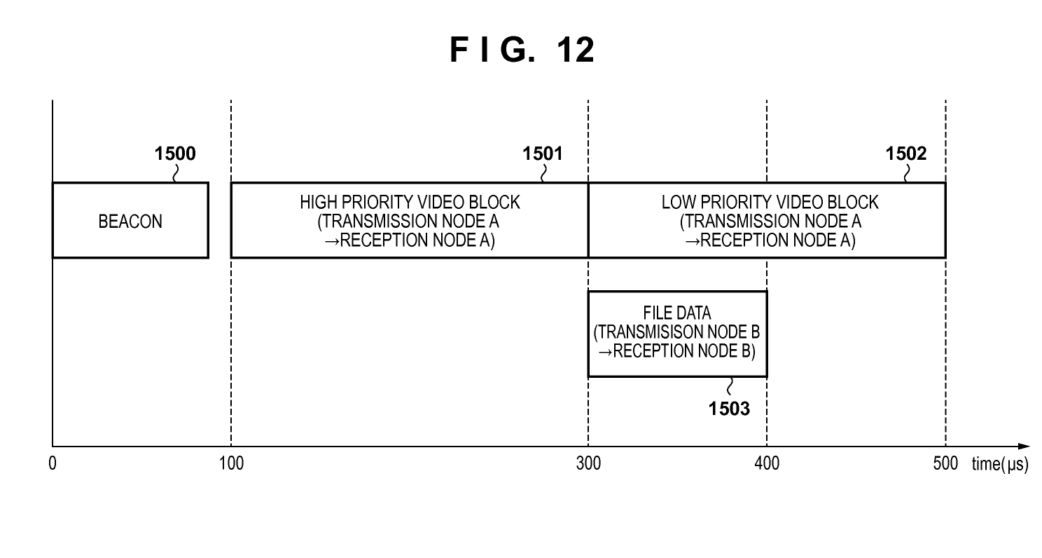

Next, an example of the control information used in the present embodiment is shown on FIG. 11A, FIG. 11B, and FIG. 12.

FIG. 11A is a view showing control information that includes function information and a timeslot allocation request communicated from the transmission node A 110 and the transmission node B 120 to the control node 100. This control information includes five information elements. An information element 1100 is an ID identifying a communication node that is a transmission source for a timeslot, and an information element 1101 is an ID identifying a communication node that is a destination of the timeslot. An information element 1102 is information indicating a length of a timeslot each transmission node requests, and is shown in units of microseconds. An information element 1103 is information indicating a type of an application requested: if the value thereof is 0, real-time video transfer is indicated; if the value thereof is 1, file transfer is indicated. The information elements 1100-1103 configure a timeslot allocation request. If video data is to be transferred, a information element 1104 is also information indicating a function to divide video data into video blocks (function information). In the information element 1104, if a value thereof is 0, transferring video line-by-line as done conventionally without performing division into video blocks is indicated, and if the value is 1, configuring with LSBs and MSBs is indicated.

From the information in the control information shown in FIG. 11A, it is understood that the transmission node A 110 requests the transfer of real-time video data having a length of 400 microseconds to the reception node A 115, and the video data can be divided into LSBs and MSBs. Simultaneously, the transmission node B 120 is requesting to transfer file data with a length of 100 microseconds to the reception node B 125. Based on this control information, the control node 100 determines the timeslot allocation at a time of spatial sharing.

FIG. 11B shows an example of the control information that includes the data block configuration information and the timeslot allocation information included in a beacon communicated from the control node 100 to all the transmission nodes and the reception nodes. The control information shown in FIG. 11B includes the data block configuration information and the timeslot allocation information determined by the control node 100 based on the function information and the timeslot allocation request of FIG. 11A. In FIG. 11B, information regarding three timeslots is shown.

An information element 1200 indicates an ID identifying a timeslot. An information element 1201 is an ID identifying a communication node that is a transmission source for a timeslot, and an information element 1202 is an ID identifying a communication node that is a destination of the timeslot. An information element 1203 is information indicating a start position for the timeslot, and indicates an offset value in units of microseconds from the head of a superframe. An information element 1204 is information indicating the length of the timeslot, and indicates a timeslot length in units of microseconds.

An information element 1205 is information indicating whether to divide video data into blocks, if video data is included in the timeslot, and how to divide if block division is to be performed. In the information element 1205, if the value thereof is 0, that indicates that video data is not included or indicates that division of video data is not performed, and if the value thereof is 1, that indicates that the video data is divided into LSB and MSB. An information element 1206 is information indicating a priority of one of the video blocks, if the video data is to be divided into blocks and then transferred, and the information element 1206 indicates the high priority video block if the value thereof is 0, and indicates the low priority video block if the value thereof is 1.

Note that regarding the lengths of timeslots allocated to the high priority block and the low priority block, the timeslot length requested by the timeslot allocation request is divided relative to the size of data of the block. In this embodiment, the higher 4 bits of each RGB data item are set as the high priority video block, and the lower 4 bits of each RGB data item are set as the low priority video block, and the amount of data for the high priority video block and the amount of data for the low priority video block are equal. Therefore, in the example of FIG. 11B, the timeslot length requested for the video data is divided into two equal parts and set as a timeslot 1 and a timeslot 2. In contrast to this, for example, if the high priority block comprises the higher 3 bits and the low priority block comprises the lower 5 bits, then the timeslot length is divided with a ratio of 3:5. In other words, the timeslot 1 allocated to the high priority block becomes 150 microseconds, and the timeslot 2 allocated to the low priority block becomes 250 microseconds. Note that it is recognized that a timeslot 3 is a file transfer from the control information of transmission node B (FIG. 11A). Therefore, the information elements 1205 and 1206 of the timeslot 3 have no meaning, and an arbitrary value is recited.

A configuration of a frame transmitted in accordance with the data block configuration information and the timeslot allocation information shown on FIG. 11B is illustrated by FIG. 12. With a beacon 1500 as the head and from a position offset by 100 microseconds, the high priority video block is transferred from the transmission node A 110 to the reception node A 115 in an interval having length of 200 microseconds (a time slot 1501). Subsequently, from a position offset by 300 microseconds, the low priority video block is transferred from the transmission node A 110 to the reception node A 115 in an interval having length of 200 microseconds (a time slot 1502). With the same the offset position as the transfer of the low priority video block (the time slot 1502), file data is transferred from the transmission node B 120 to the reception node B 125 in an interval having a length of 100 microseconds (a time slot 1503). In other words, file data is transferred in a state that temporally overlaps with the time slot 1502 (the low priority video block). In this way, the time slot 1501 for the high priority video block is not caused to overlap with another timeslot, and the time slot 1502 for the low priority video block is caused to overlap with the time slot 1503 for file data. Thus, reducing occurrences of reception errors of a high priority video block (the time slot 1501) while efficiently using communication bandwidth becomes possible.

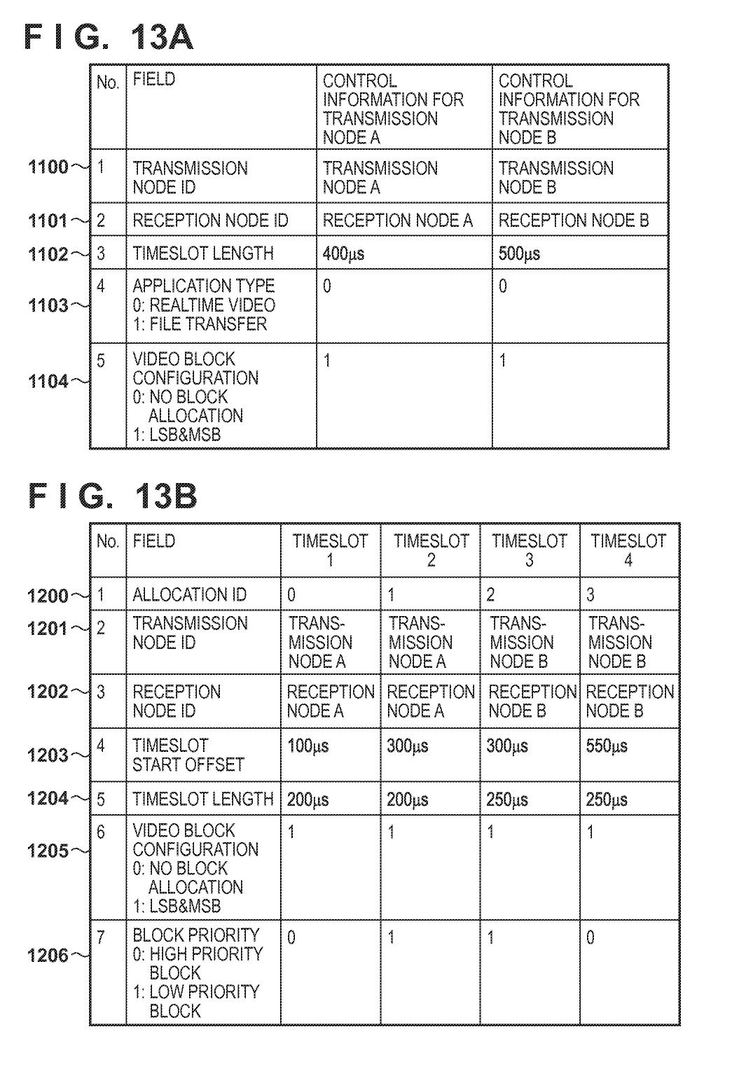

FIG. 13A illustrates control information that includes function information relating to a configuration of a video block and an allocation request for timeslots, when the transmission node A 110 and the transmission node B 120 both request transfer of real-time video. It is understood from this control information, that the transmission node A 110 requests to transfer real-time video data 400 microseconds in length to the reception node A 115, and the video data can be divided into LSBs and MSBs. Simultaneously, the transmission node B 120 requests to transfer real-time video data of length 500 microseconds to the reception node B 125, and the video data can be divided into LSBs and MSBs.

FIG. 13B illustrates control information the control node 100 determines based on the control information of FIG. 13A (function information relating to a configuration of a video block and an allocation request for timeslots). Similar to FIG. 11B, the control information contains allocation information indicating the timeslot allocation and configuration information indicating the configuration of the video blocks. Each information element in the control information shown in FIG. 13A and FIG. 13B is similar to that in FIG. 11A and FIG. 11B.

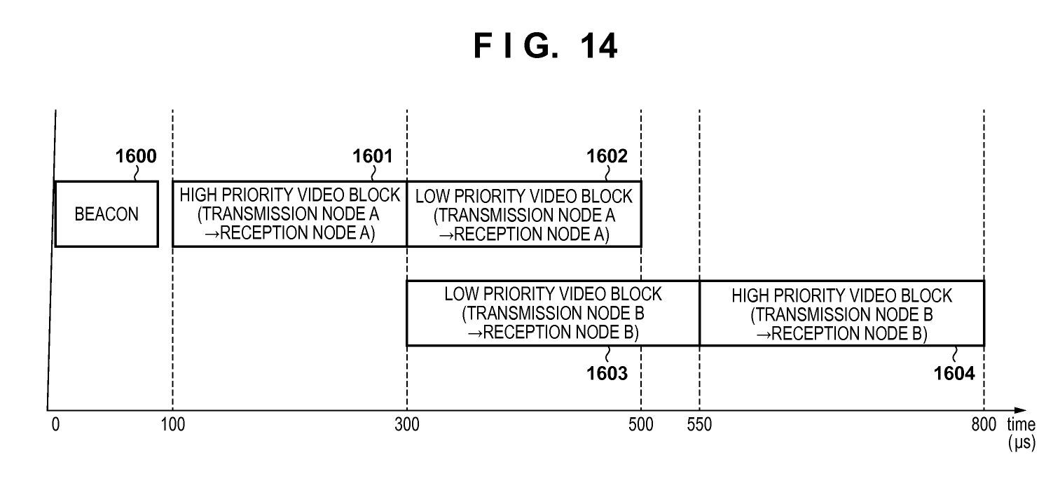

An example of the arrangement of a frame transmitted by the control node 100 after the control node 100 determines in accordance with this allocation information and configuration information is shown in FIG. 14. A beacon 1600 is set as the head, and the high priority video block is transferred from the transmission node A 110 to the reception node A 115 in an interval 200 microseconds in length from a position offset by 100 microseconds (a time slot 1601). Subsequently, a low priority video block is transferred from the transmission node A 110 to the reception node A 115 in an interval 200 microseconds in length from a position offset by 300 microseconds (a time slot 1602). With the same offset as the transfer of this low priority video block (the time slot 1602), a low priority video block is transferred from the transmission node B 120 to the reception node B 125 in an interval 250 microseconds in length (a time slot 1603). Accordingly, transfer of the low priority video block from the transmission node A 110 to the reception node A 115 temporally overlaps with transfer of the low priority video block from the transmission node B 120 to the reception node B 125.

Subsequently, a high priority video block is transferred from the transmission node B 120 to the reception node B 125 in an interval 250 microseconds in length from a position offset by 550 microseconds (a time slot 1604). In this way, in a case of causing timeslots for real-time video transfer to overlap each other, low priority video block timeslots are overlapped without overlapping high priority video block timeslots. By doing this, occurrence of reception errors of a high priority video block in the time slot 1601 and the time slot 1604 are caused to be reduced, while efficiently using communication bandwidth.

As described above, according to the first embodiment, the control node 100:
classifies data transmitted by a transmission node into a first type for which spatial sharing is inhibited, and a second type for which spatial sharing is allowed; and
allocates data classified as the first type to a timeslot after inhibiting spatial sharing, and allocates data classified as the second type to a timeslot after causing spatial sharing to be performed. In other words, according to the present embodiment, by selectively performing spatial sharing in a timeslot included in one superframe, reliable transfer of data for which a real-time capability is requested and utilization of bandwidth through spatial sharing are both achieved.

For example, by:
setting a portion of stream data necessary for maintaining continuity of playback as data classified into the first type;
setting a supplementary portion of stream data that contributes to playback quality as data classified into the second type; and
setting data for which errors can be reduced by retransmission even if a reception error occurs, such as file data, as data classified into the second type;

playback of stream data is able to continue without causing a discontinuation, even if an error occurs in transmission/reception of data through spatial sharing.

As a concrete example of data of the first type and the second type, in the first embodiment video source data is divided into LSBs of low priority (the second type) and MSBs of high priority (the first type). Then the timeslot to which the LSBs are allocated is caused to overlap temporally with another timeslot (for example, a timeslot to which file transfer is allocated or LSBs for another video source), and spatial sharing is performed. Thereby, it is possible to perform spatial sharing in a state in which interference to the MSBs of high priority is avoided. Accordingly, even if an error occurs in LSB which has a smaller effect on human vision, it is possible to continue video playback without strangeness by using MSB data.

Note that in the first embodiment explanation was given for an example of transferring the video data, but the present invention is not limited to this, and for example, can also be applied to another application for which real-time capability is requested, such as transfer of audio data. For example, in the case of audio data, configuration may be taken to include a low-frequency component of the audio data, for which human auditory perception is sensitive, in the high priority block, and to include a high-frequency component of the audio data, for which human auditory perception is not sensitive, in the low priority block. By inhibiting temporal overlap of the high priority block, it is possible to reduce discontinuation or deterioration for audio playback.

### Second Embodiment

In the first embodiment, the source video data was divided into MSBs and LSBs with a state of no compression, and the sizes of video blocks was the same for low priority and high priority. In the second embodiment, an example is shown of a case in which scalable video compression, having a variable compression rate, is applied, and the sizes of low priority and high priority video blocks is determined according to an allocation request for timeslots that are caused to overlap. In the second embodiment, the transmission node transmits compressed data for video via the high priority block, and transmits loss data, which disappears from the source video data at the time of video compression, through the low priority block. The reception node can generate the original source video data by decompressing the received compressed data and synthesizing the decompressed data with the received loss data.

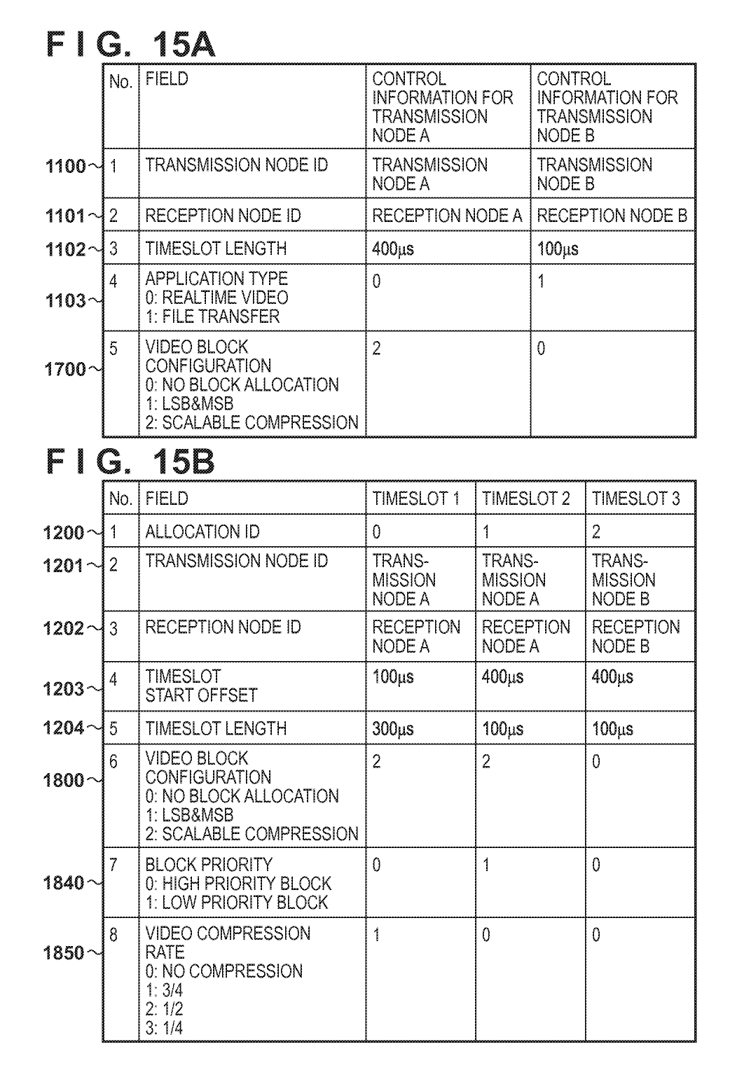

FIG. 15A displays control information that includes video block configuration information and a timeslot allocation request, for when supporting video compression. Compared to FIG. 11A, an information element 1700, which is video block configuration means information, with a value “2” for when scalable compression is applied, has been newly added. It is understood from this information that the transmission node A 110 requests to transfer real-time video data 400 microseconds in length to the reception node A 115, and it is possible to apply scalable compression to that video data. Simultaneously, the transmission node B 120 is requesting to transfer file data with a length of 100 microseconds to the reception node B 125.

FIG. 15B illustrates control information that includes configuration information for a video block and allocation information for a timeslot determined by the control node 100 based on the control information shown by FIG. 15A (function information relating to a video block configuration and an allocation request for a timeslot). Compared to FIG. 11B, an information element 1800, which is video block configuration information, with a value “2” for when scalable compression is applied, has been newly added. An information element 1840 indicates a block priority, indicating a high priority block if the value thereof is zero, and a low priority block if the value thereof is one. If the block configuration is LSBs and MSBs, the high priority block is a block for the MSB side, and the low priority block is the block for the LSB side. If the block configuration is for scalable compression, the high priority block is compressed data for video, and the low priority block is the loss data.

An information element 1850 is information indicating a compression rate for compressed video transferred in the high priority block when scalable compression is applied. The value of the information element 1850 being zero indicates that compression is not applied, the value being 1 indicates 3/4 compression of the source video data, the value being 2 indicates 1/2 compression, and the value being 3 indicates 1/4 compression. The transmission node uses the compression rate indicated by this information to perform video compression on the source video data. The reception node also implements video decompression based on the compression rate indicated by this information, and performs synthesis with the loss data to generate the source video data, if the loss data could be received correctly.

When determining timeslot allocation, the control node 100 determines a video compression rate so that the timeslot length for transferring loss data and the timeslot length for other data transferring, which is caused to overlap with the loss data, match as much as possible. In this example, the timeslot length for file data caused to overlap with the loss data is 100 microseconds. Accordingly, the timeslot length for the loss data should be set to 100 microseconds, the video compression rate is set to 3/4, and the length of the timeslot that transfers the compressed video block is 300 microseconds.

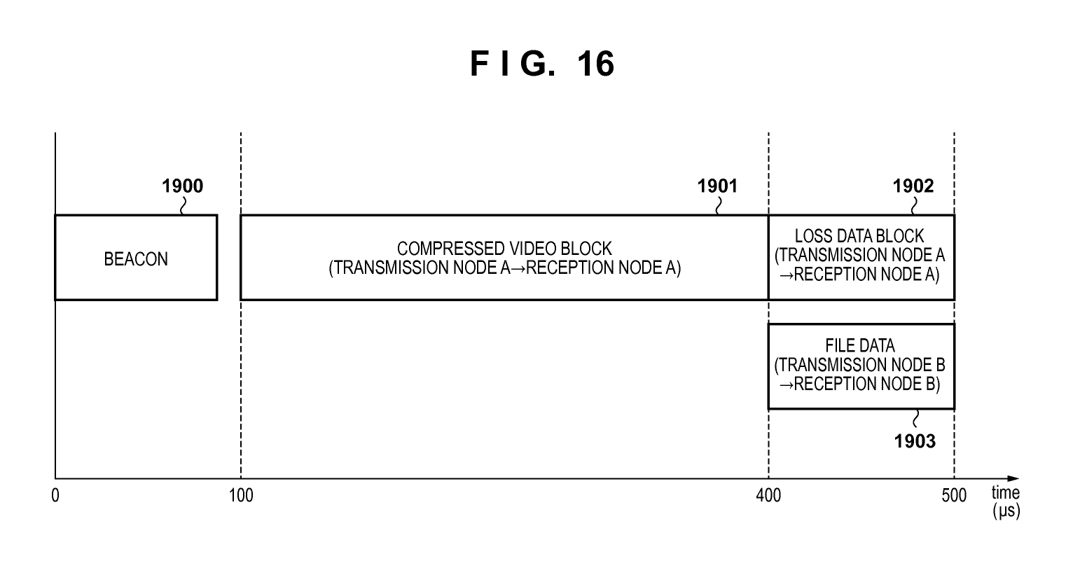

An example configuration of a frame transmitted in accordance with the video block configuration information and the timeslot allocation information shown on FIG. 15B is illustrated by FIG. 16. A beacon 1900 is set as the head, and the compressed video block is transferred from the transmission node A 110 to the reception node A 115 in an interval 300 microseconds in length from a position offset by 100 microseconds (a time slot 1901). Subsequently, a loss data block is transferred from the transmission node A 110 to the reception node A 115 in an interval of length 100 microseconds from a position offset by 400 microseconds (a time slot 1902). In an interval 100 microseconds in length from the same offset position as the time slot 1902 for transferring this loss data block, file data is transferred from the transmission node B 120 to the reception node B 125 (a time slot 1903). Accordingly, the loss data block (the time slot 1902) and the file data (the time slot 1903) are transferred in a temporally overlapped state. In this way, according to the second embodiment, the compression rate for video data is determined so that the length of the low priority loss data block aligns with the length of file data with which the low priority loss data block is caused to overlap. Thereby, it is possible to improve the quality of video transferred with the compressed video block by shortening the length that is overlapped.

Thereby, compared to the case as shown in FIG. 12 of simply dividing source video data into MSBs and LSBs and then transferring the divided video data, it is possible to improve the quality of video played by using the high priority video block when an error occurs in the low priority video block.

As described above, according to each embodiment, it is possible to reduce discontinuation or deterioration of streaming playback or the like, when executing wireless communication in which timeslots are caused to overlap (wireless communication in which spatial sharing was performed).

Note that the above explanation is only one example of an embodiment of the present invention, and that the present invention is not limited to this embodiment goes without saying.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-163045, filed Aug. 8, 2014 which is hereby incorporated by reference herein in its entirety.

What is claimed is:

1. A communication apparatus, comprising:
an allocation unit configured to allocate timeslots, indicating intervals usable for transmission or reception of data, to each of a first communication apparatus and a second communication apparatus; and
a notification unit configured to communicate a result of the allocation by the allocation unit to the first communication apparatus and the second communication apparatus,
wherein the allocation unit allocates the timeslots so that,
from the timeslots allocated to the first communication apparatus and the timeslots allocated to the second communication apparatus,
a timeslot allocated for the first communication apparatus to transmit or receive a first type of data to or from a partner apparatus is caused to overlap with a timeslot allocated for the second communication apparatus to transmit or receive the first type of data to or from a partner apparatus, and
a timeslot allocated for the first communication apparatus to transmit or receive a second type of data to or from a partner apparatus is caused not to overlap with a timeslot allocated for the second communication apparatus to transmit or receive the second type of data to or from a partner apparatus.

2. The apparatus according to claim 1, wherein
the first type of data and the second type of data are stream data, and
the first type of data is a portion of the stream data necessary to maintain continuity of playback, and the second type of data is a supplementary portion of the stream data that contributes to a quality of playback.

3. The apparatus according to claim 2, wherein
the stream data is video data, color information in the video data is classified into an MSB side and an LSB side, and the portion necessary to maintain continuity of playback is, a portion obtained for the MSB side of the color information, and the supplementary portion is a portion obtained for the LSB side of the color information.

4. The apparatus according to claim 2, wherein
the portion necessary to maintain continuity of playback is compressed data of the stream data, and the supplementary portion is loss data that disappeared in the compressed data.

5. The apparatus according to claim 4, further comprising:
a designating unit configured to designate a compression rate for the compressed data based on a duration of overlapped timeslots.

6. The apparatus according to claim 5, wherein
the designating unit determines the duration of the overlapped timeslots, and designates the compression rate for the compressed data based on a duration of a timeslot that is not overlapped, which is determined based on the duration of the overlapped timeslots.

7. The apparatus according to claim 1, further comprising:
an obtaining unit configured to obtain an interference amount between a communication link between the first communication apparatus and partner apparatus, and a communication link between the second communication apparatus and partner apparatus, wherein
the allocation unit inhibits overlapping even for timeslots allocated for transmission or reception of the first type of data when the interference amount obtained by the obtaining unit is greater than or equal to a predetermined threshold.

8. The apparatus according to claim 1, wherein
the notification unit communicates to the first communication apparatus and the second communication apparatus by including the result of the allocation in a beacon.

9. A communication apparatus operable to manage timeslots which are for a plurality of nodes to time-divisionally transmit/receive data in a wireless communication network, comprising:
a classification unit configured to classify data transmitted/received by the plurality of nodes into data that falls under a first type and data that falls under a second type; and
an allocation unit configured to allocate data that falls under the first type to a timeslot for which spatial sharing is inhibited, and allocate data that falls under the second type to a timeslot for which spatial sharing is caused to occur.

10. The apparatus according to claim 9, further comprising
a division unit configured to divide timeslots allocated for data transmitted from one node into a first timeslot for transmission of data that falls under the first type, and a second timeslot for transmission of data that falls under the second type, wherein
the allocation unit inhibits spatial sharing of the first timeslot, and causes spatial sharing of the second timeslot.

11. A control method for a communication apparatus, the method comprising:
allocating timeslots, indicating intervals usable for transmission or reception of data, to each of a first communication apparatus and a second communication apparatus; and
communicating a result of the allocation in the allocation step to the first communication apparatus and the second communication apparatus,
wherein, in the allocating, the timeslots are allocated so that,
from the timeslots allocated to the first communication apparatus and the timeslots allocated to the second communication apparatus,
a timeslot allocated for the first communication apparatus to transmit or receive a first type of data to or from a partner apparatus is caused to overlap with a timeslot allocated for the second communication apparatus to transmit or receive the first type of data to or from a partner apparatus, and
a timeslot allocated for the first communication apparatus to transmit or receive a second type of data to or from a partner apparatus is caused not to overlap with a timeslot allocated for the second communication apparatus to transmit or receive the second type of data to or from a partner apparatus.

12. A control method for a communication apparatus configured to manage timeslots which are for a plurality of nodes to time-divisionally transmit/receive data in a wireless communication network, the method comprising:
classifying data transmitted/received by the plurality of nodes into data that falls under a first type and data that falls under a second type; and
allocating data that falls under the first type to a timeslot for which spatial sharing is inhibited, and allocate data that falls under the second type to a timeslot for which spatial sharing is caused to occur.

13. A non-transitory computer-readable storage medium storing a computer program for causing a computer to execute a control method comprising:
allocating timeslots, indicating intervals usable for transmission or reception of data, to each of a first communication apparatus and a second communication apparatus; and
communicating a result of the allocation in the allocation step to the first communication apparatus and the second communication apparatus,
wherein, in the allocating, the timeslots are allocated so that,
from the timeslots allocated to the first communication apparatus and the timeslots allocated to the second communication apparatus,
a timeslot allocated for the first communication apparatus to transmit or receive a first type of data to or from a partner apparatus is caused to overlap with a timeslot allocated for the second communication apparatus to transmit or receive the first type of data to or from a partner apparatus, and
a timeslot allocated for the first communication apparatus to transmit or receive a second type of data to or from a partner apparatus is caused not to overlap with a timeslot allocated for the second communication apparatus to transmit or receive the second type of data to or from a partner apparatus.

14. A non-transitory computer-readable storage medium storing a computer program for causing a computer to execute a control method for a communication apparatus configured to manage timeslots which are for a plurality of nodes to time-divisionally transmit/receive data in a wireless communication network, the method comprising:
classifying data transmitted/received by the plurality of nodes into data that falls under a first type and data that falls under a second type; and
allocating data that falls under the first type to a timeslot for which spatial sharing is inhibited, and allocate data that falls under the second type to a timeslot for which spatial sharing is caused to occur.
